(19) United States
(12) Patent Application Publication
(10) Pub. No.: US 2026/0300879 A1
(43) Pub. Date: Oct. 1, 2026

(54) SYSTEMS AND METHOD UTILIZING LARGE LANGUAGE MODELS TO SUMMARIZE AND INTERPRET OUTPUTS FROM AUTOMATED HAZARD DETECTION SYSTEMS AND RECOMMEND ACTIONS

(71) Applicant: Exebenus AS, Stavanger (NO)

(72) Inventors: Saba Suhail, Hayward, CA (US); Timothy S. Robinson, Miami, FL (US); Olav E. Revheim, Stavanger (NO); Paal Bekkeheien, Miami, FL (US)

(21) Appl. No.: 19/572,491

(22) Filed: Mar. 19, 2026

Related U.S. Application Data
(60) Provisional application No. 63/777,991, filed on Mar. 26, 2025.

(51) Int. Cl. G06Q 10/0635; G06F 16/34; G06N 5/02; G06N 20/00; G06Q 50/02

(52) U.S. Cl. CPC G06Q 10/0635; G06F 16/345; G06N 5/02; G06N 20/00; G06Q 50/02

(57) ABSTRACT

The disclosure describes a method and framework for linking one or more operational hazard detection systems to natural language processing tools, such as large language models, for improving and automating the processes of information retrieval during a hazard situation, provision of interpretations relating to the hazard scenario as well as recommended actions for mitigating the hazard in accordance with best practices in a particular operational context. Example embodiments are provided for Summarization-Interpretation and Recommendation (SIR) systems focused on various hazards detected during subterranean well construction operations using a rotary drilling rig, such as stuck pipe, vibrations and tool failures, which are potential sources of major non-productive time.

### CROSS-REFERENCE TO RELATED APPLICATION

This application claims the benefit of U.S. Provisional Application No. 63/777,991 filed on Mar. 26, 2025, which is incorporated herein by reference in its entirety.

### TECHNICAL FIELD

The present disclosure relates generally to a framework and methodology for integrating real-time hazard detection systems with a system utilizing the Artificial Intelligence (AI) methodologies of generative Large Language Models (LLMs) and Retrieval Augmented Generation (RAG) for providing context-informed summaries, interpretations and recommended actions to mitigate the identified hazards. A challenge often faced with operational hazard detection systems is that the correct actions to take in response to risk alerts may not always obvious to the alerts' consumers, and retrieving this information may be time consuming and/or infeasible under high stress conditions often associated with hazard scenarios. This is particularly the case when risk scenarios are indirectly or imperfectly observed, an example of which includes hazards faced while drilling subterranean wells utilizing a rotary drilling rig, where the sources of hazards may be kilometers underground, and where the ability to characterize them is limited to surface measurements and/or certain downhole measurement tools.

### BACKGROUND

Industrial operations and processes often face various hazards that can occur while they are in progress; some of these risks can be minimized, for example through effective planning, selection of appropriate equipment, or establishing safe operational practices, while for other hazards that cannot be eliminated through actions taken during pre-operational phases, systems and processes for real-time risk detection and mitigation are required to ensure safety.

Current systems may be effective at identifying symptoms or leading indicators of risks or hazards, however their capabilities for providing detailed insights and recommendations appropriate for a specific operational context have historically been limited to basic instructions generated by rules-based systems, or omitted entirely from the operational hazard detection process and left to human monitoring staff to decide on. In addition, in operational contexts where multiple different forms of hazard may be relevant, the prior art does not provide a unifying framework for integrating one or more hazard detection systems with automated capabilities for summarization of risks, generation of contextually-informed interpretations and insights as well as recommended actions for mitigating the hazards. In various contexts, information that may inform operational decision making may be available in principle but may also be either difficult to retrieve promptly during an ongoing hazard situation, or practically inaccessible due to information residing in various databases or libraries without direct links to operations. Example information that could assist with decision-making might include reports documenting prior experiences during operationally similar projects, best practices for particular (possibly infrequently occurring) scenarios and standard operating procedures for a particular project, or even reference books and technical articles. These challenges with information retrieval and provision to recipient beneficiaries may mean that projects or teams facing certain operational hazards may not be optimally informed with respect to the best course(s) of action to take in response to a hazard encountered in a specific context, even in cases where they are alerted to the risk by real-time hazard detection system. A major challenge in deploying LLMs for high-risk environments, such as industrial risk management, is the limited applicability of non-guided models due to overly generic outputs and hallucinations. Without proper constraints or domain adaptation, LLMs tend to produce vague or non-specific responses lacking in insights, making them ineffective for decision-making, and sometimes generate incorrect or fabricated information, which can be misleading or even dangerous in applications where accuracy and reliability are critical.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a methodology and system framework for integrating one or more real-time operational hazard detection systems with another system utilizing the Artificial Intelligence techniques of generative Large Language Models (LLMs) and Retrieval Augmented Generation (RAG) for providing context-informed summaries, interpretations and recommended actions to mitigate any identified hazards. For brevity, this system will herein be referred to as the Summarization-Interpretation-Recommendation (SIR) system. The disclosed framework and method is general-purpose, and does not assume usage of any specific LLM or vector database for RAG; any appropriate version of these may be used as components of the SIR system, and thus these components are treated as commoditized and interchangeable in the context of this invention.

The SIR system receives data from the hazard detection system(s) and stores this in a database, then generates a summary from this information that describes the risk scenario present in the data (if any), and requests interpretations for the summarized risk scenario from a module utilizing a generic LLM integrated with an external knowledge base containing up-to-date and relevant information used for RAG. Optionally, a follow-up request to the LLM can be made for recommendations for actions that follow best practices for resolving the summarized and interpreted risk scenario, where information on best practices in this context can be retrieved from a vectorized document collection, and returned to an end-user responsible for deciding whether to implement the actions through an appropriate distribution channel. Specific embodiments of the SIR system may use a variety of distribution channels, including but not limited to email notifications, text messages (for example through SMS, or internet-based instant messaging services), displaying the system outputs in a Graphical User Interface (GUI) of a software application that could optionally include a “chat” function or conversational agent, writing text outputs to a generic remote database, or providing audio output through use of text-to-speech software.

### BRIEF DESCRIPTION OF THE DRAWINGS

FIG. 1 provides an example of an embodiment, an overview of key rig site systems, sensors and data flow to computational infrastructure used by hazard detection systems and the SIR system.

FIG. 2A illustrates an overview of the process of summarization of alerts from a linked hazard detection system.

FIG. 2B describes an example embodiment of the process of summarization of real-time hazard alerts raised in the context of drilling subterranean wells with a rotary drilling rig, where the summarization module is linked to hazard detection system(s) focused on risks of stuck pipe and their early identification.

FIG. 3A represents a high-level overview of the process of transformation of summary objects created by the Summarizer module, and subsequent querying of the LLM to obtain interpretations in natural language and recommendations for mitigation of the problems indicated by hazard-related context captured in the summary objects.

FIG. 3B represents an overview of the process of querying of summary objects created by the summarizer module in the context of drilling subterranean wells with a rotary drilling rig, where the summarization module is linked to a hazard detection system focused on risks of stuck pipe by the LLM to produce interpretations and recommendations.

FIG. 3C illustrates an example prompt template used during the custom prompt building process.

FIG. 4 illustrates a diagrammatic representation of creation of a vector store populated by processing a set of documents relevant to the various hazards targeted by the detection system(s), using a generic vector database tool.

FIG. 5 represents the integration of a module responsible for summarization of alerts from one or more hazard detection system(s) with an LLM via a Question-Answering (QA) chain module, a structured pipeline used to process and respond to queries.

FIG. 6A illustrates a generic few-shot prompt template technique applied within the scope of the SIR system. Few-shot prompting is an approach where an LLM is provided with a few examples (input-output pairs) in the prompt to guide its response generation.

FIG. 6B illustrates an embodiment of the few-shot prompt template technique applied in conjunction with a hazard detection system. This module uses a few-shot prompt template approach in prompt generation to guide the LLM on the format of output responses, if it is a system-generated summary object describing the output information from a hazard detection system.

FIG. 7A provides an overview of an LLM-based conversational agent used to process inputs from users obtained from a user interface of a software application, or a system-generated summary into context-aware responses.

FIG. 7B describes a process, in scope of the conversational agent, for supporting a user's preferences, in terms of preferred language in which to receive the text responses, and data sources from which to retrieve contextual information.

FIG. 8 illustrates an embodiment where SIR framework is integrated with a drilling dysfunction detection system focused on torsional vibrations (stick-slip) that may occur during well construction operations with a rotary drilling rig.

FIG. 9 shows example outputs generated by the torsional vibration hazard detection system, for consumption by the SIR system embodiment illustrated in FIG. 8.

FIG. 10 illustrates an embodiment where SIR framework is integrated with a hazard detection system focused on detecting risks of failure of downhole positive displacements motors during well construction operations with a rotary drilling rig.

FIG. 11 shows example outputs generated by the hazard detection system targeting potential failures of positive displacement motors, for consumption by the SIR system embodiment illustrated in FIG. 10.

FIG. 12 illustrates an embodiment where hazard information is manually provided by a user in a structured format through a user interface on their local computer, and transmitted to the SIR system.

FIG. 13 illustrates an embodiment where hazard information is manually provided by a user through free text input to a conversational agent (chat) software interface accessible with their local computer, and transmitted to the SIR system.

FIG. 14 illustrates an embodiment combining user-provision of information pertaining to a predefined set of hazards in a structured format and a conversational interface for follow-up questions and provision of information about the possible hazards in natural language form.

FIG. 15 shows an example mockup of a user interface for use in an embodiment combining user-provision of hazard information in a structured format, as well as via a conversational interface for follow-up questions and provision of information about the possible hazards in natural language form.

FIG. 16 shows example outputs from an embodiment where both stuck pipe and vibration risks are detected by two hazard detection systems linked to the SIR system, displayed in the form of a screenshot from a commercial well-log visualization software application.

FIG. 17 shows example natural language outputs generated by the SIR system pertaining to the risk scenario presented in FIG. 16, in the form of a summarized risk perspective, with interpretations of the perspective and recommended actions.

### DETAILED DESCRIPTION

The present disclosure introduces a method and system framework for integration of one or more real-time hazard detection systems with a sub-system utilizing an LLM with RAG to produce context-aware summaries, interpretations and recommendations for actions to mitigate risks encountered during operations, in various industrial contexts. The following detailed description offers additional guidance to assist one of ordinary skill in the art in understanding the figures and example implementations during the exploration phase of the present application.

The disclosed framework and method is general-purpose, and does not assume usage of any specific LLM or vector database for RAG; any appropriate version or implementation of these may be used as components of the SIR system, and thus these components are treated as commoditized and interchangeable in the context of this disclosure. The SIR system receives data from one or more hazard detection system(s) and stores this in a database, then generates a summary object from this information that describes the risk scenario present in the data (if any), exemplified by a JSON-like format. The contents of these summarized risk scenarios are then incorporated into a custom-built prompt, which is used in requests for interpretations and initial recommendations from a QA chain module utilizing a generic LLM integrated with an external knowledge base containing up-to-date and relevant information used for RAG. Optionally, a follow-up request to the LLM can be made for further recommendations for actions that follow best practices for resolving the summarized and interpreted risk scenario, where information on best practices in this context can be retrieved from a vectorized document collection, and returned to an end-user responsible for deciding whether to implement the actions through one or more distribution channels. These channels may include, but are not limited to, email notifications, SMS messages or messages sent using an alternative internet-based messaging service, displaying the interpreted hazard scenarios and recommended actions on a Graphical User Interface (GUI) of a software application, or providing audio outputs through use of a text-to-speech software tool and an electronic speaker co-located with the user for playback. The method for integration of outputs from an LLM into any or all of these channels for presentation to humans will be known and understood by one of ordinary skill in the art.

A particular hazard detection system may focus on a single hazard type or alternatively may include sub-systems within its scope that detect multiple different types of related hazards. A plurality of risk detection methodologies may be utilized within scope of a particular hazard detection system, including one or more of the following; machine learning techniques and models, physics-based models and algorithms, change point detection algorithms, or rules-based logic. Similarly from a functional perspective, multiple distinct hazard detection systems may provide outputs that are consumed by the SIR system. Risk outputs from a plurality of targeted hazards may be merged for further processing by a connected module that summarizes the risk scenarios (if any) into a summary object. This summarizer module may be customized and extended according to the specific combination of operational hazards considered to be within scope of the system. The summaries may be generated in an event-driven manner, for example whenever a new risk alert is generated, or alternatively generated at regular intervals (for example defined by time, or displacement) in a sequential manner. The hazard detection systems may for example relate to well construction operations utilizing a rotary drilling rig, mining operations, operation of heavy industrial equipment, among others. The generated summary object is a concise state object, in a format typically comprehensible by LLMs (for example JSON-like), that captures and aggregates information about the alerts from hazard detection system/systems in various frames of reference. These frames of reference may be defined by measured variables such as time, depth, displacement, or another appropriate measured quantity applicable to a particular hazard detection system or industry context in which the system is used. The contents of these summary objects are then automatically incorporated into a customized prompt with instructions for the LLM and passed to the QA chain module. The vector store used for context retrieval by the QA chain may contain a range of relevant documents, that may relate to industry practices, interpretation guidelines for the hazard detection system or the hazard itself, or alternatively technical articles, reports, or books concerning the industry in which hazard detection system is being used.

As the disclosed framework methodology and system can be applied in a plurality of applications involving real-time hazard detection, there are many possible embodiments that could be applied to different use-cases. Implementation of these different embodiments requires some adaptation of key components according to the use-case, namely the interface logic with linked hazard detection systems, intermediate data storage, summarization logic, and the QA chain, in order to facilitate integration with a plurality of hazard detection systems, and generation of meaningful summarized risk scenarios and interpretations for these. The contents of the document collection(s) in the vector store(s) used as external knowledge bases will also vary according to the operational context and hazard type being monitored. Under some embodiments, the QA chain setup could directly receive information about operational hazards from a human user via a conversational agent interface for natural language input, or a user interface facilitating manual addition of risk information regarding a predefined set of risk types, or a combination of these two functionalities. Alternatively, other embodiments may fully automate the process of obtaining hazard information, for example by directly integrating with one or more hazard detection systems or accessing a common database to which the hazard detection systems independently write their outputs.

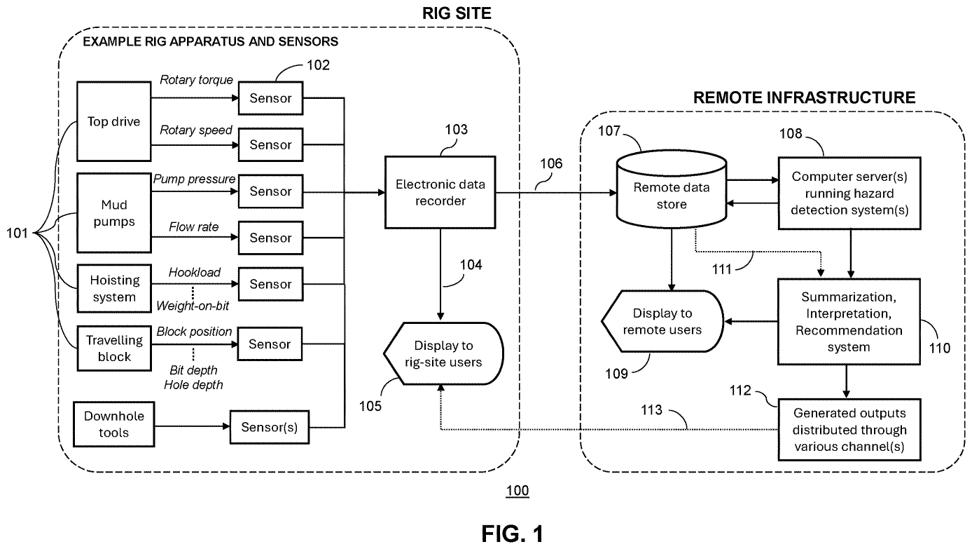

With reference to FIG. 1, several of the embodiments applying the SIR system methodology described herein relate to a plurality of hazards encountered during the processes of subterranean well construction utilizing a rotary drilling rig, and provision of summarized risk perspectives, interpretations and recommended actions pertaining to these. This operational environment is used as an example of an industrial operation where hazards may occur to demonstrate the relationship between operational hazards and the invention. Persons familiar with the art of other industrial operations would be familiar with the operations and therefore be able to see the relationships between the industrial hazards and the invention. To provide context for the reader, an overview of how data may be measured at the rig site is aggregated, transmitted to remote server infrastructure and utilized by the SIR system embodiments is presented in FIG. 1. Various critical rig systems at surface 101 have integrated sensors 102 measuring key variables that are essential for characterizing a rig operation, for example measurements of rotary torque exerted by the top drive system on the drill string and the associated rotary speeds; pump pressures and mud flow rates measured at the mud pumps; hook-load measurements measured with a weight sensor at the hoisting system (and weight-on-bit estimates calculated from this); and block position measurements associated with the travelling block, from which bit depths and hole depths are calculated. Optionally, in some apparatus configurations, one or more downhole tools may be included with the bottomhole assembly (BHA) for measuring downhole characteristics; examples of these include accelerometers for shock and vibration measurements, or gamma ray detectors, resistivity measurement tools, neutron porosity tools and sonic logging tools for geological formation characterization “near” to the drill bit. During operations, data from downhole tools may be uplinked to surface via methods such as mud pulse telemetry or wired pipe (usually with a periodicity of a few minutes), or logged in the measurement tools' memory and for later retrieval once the tool is back at surface. These data retrieval frequency limitations also limit the usage of downhole tools in real-time hazard detection workflows, although they may be useful for diagnosing hazard types that develop over much longer timescales that the periodicity of data up-linking. Data measured by the various sensors 102 is aggregated by the electronic data recorder (EDR) 103, sent via data feed 104 for display on rig-site computers for local users 105, and transmitted via data feed 106 to a remote data store 107 located on remote computer server infrastructure. The hazard detection system(s) 108, which may also deployed on remote servers, read data from the remote data store 107, extract information pertaining to operational risks (in real-time or for retrospective analysis), and publish this risk information back to the remote data store 107, from where the data may optionally be read and visualized by remote users 109. The SIR system 110 may directly receive hazard information from the hazard detection system(s), or in some configurations may retrieve the hazard information via a query 111 to the remote data store(s). The content generated by the SIR system is then distributed through one or more channels 112, which might include displaying in a GUI, email notifications or internet-based messaging services, writing to a remote database, or as audio output through use of a text-to-speech software tool. The outputs may also be transmitted back to the rig site 113 and then displayed to rig site users on a local computer 105.

The aforementioned example embodiments of the SIR system linked to hazard detection systems focused on operational risks encountered during well construction may be set up to support operations occurring at one or more active well sites. When deployed to a remote server in the “cloud”, which allows utilized computational infrastructure to be easily scaled up or down, the system may be used to monitor and provide interpretations and recommendations for multiple concurrent well operations, or alternatively it may be deployed at a specific rig site on a local computer, in which case the system will monitor operations for that particular well site.

An illustrative specific embodiment of a SIR system in the context of hazards detected during subterranean well construction may focus on risks of stuck pipe, which can result in costly non-productive time if not properly mitigated. The linked stuck pipe risk detection system receives operational data measured by sensors at the rig-site, analyzes this data for identifications of risk symptoms or leading indicators of hazards, and publishes this information to a remote database for usage by teams responsible for monitoring operations. This information is in turn utilized by the Summarizer module to generate a risk scenario summary object, which is passed to the QA chain module responsible for generating context-informed interpretations relating to the underlying stuck pipe mechanism, and recommended actions for mitigating any identified risks. The interpretations and recommended actions are generated using an LLM and RAG, where context is retrieved from a vector database containing vectorized documents that might include materials on best practices for mitigating different types of well construction risks, standard operating procedures for the Operator (for the specific well being drilled or more generally), documentation for the stuck pipe risk detection system, or any other relevant resources in the form of natural language.

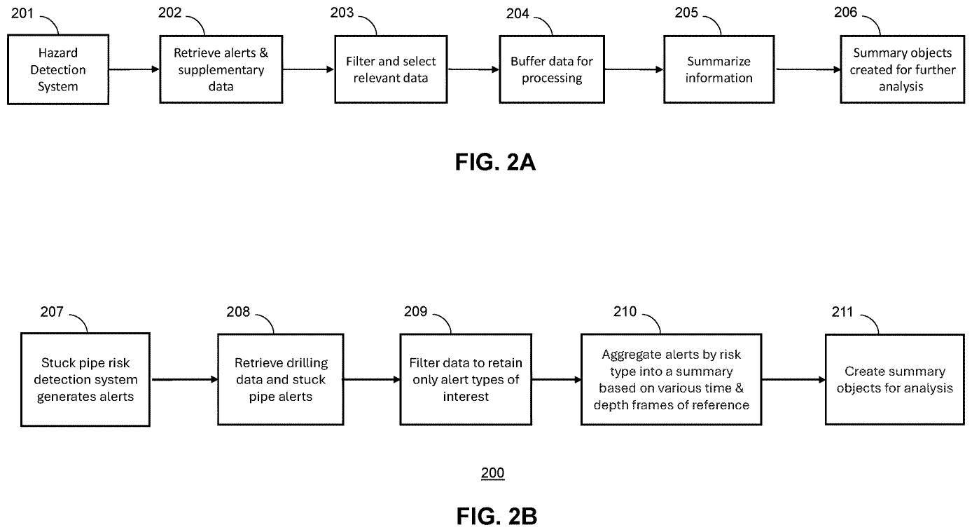

With reference to FIG. 2A, an illustration of the processing of outputs from hazard detection system into summary objects is provided. Hazard detection system 201 produces output information 202 which is processed to filter for risk alerts 203 for various time frames and/or other reference windows 204. For each reference window, a cumulative count of all warnings encountered so far in that reference 205 is attached to it, to create a summary object 206. If the hazard detection system can generate multiple distinct types of warnings corresponding to different forms of risk, these may be cumulatively summed separately within the configured frames of reference to provide a more detailed description of the risk scenario. This module which produces summary objects from the output of the linked hazard detection system(s) will herein be referred to as the Summarizer module.

With reference to FIG. 2B, an embodiment of the Summarizer module could be implemented to integrate with a real-time hazard detection system focused on risks of stuck pipe during well construction operations utilizing a rotary drilling rig. During real-time operations, the outputs generated by the stuck pipe risk detection system 207 are processed to obtain a history of alerts 208, which is stored in a memory buffer. These alerts are indexed according to the times and measured depths at which they were raised 209 and may include multiple different types of alerts according to the specific underlying risk mechanism that identified the hazard. The Summarizer module then calculates a set of descriptive statistics 210 relating to the hazard alerts raised within configured frames of reference, which may be defined in time, or in displacement from the current location of the drill bit described by measured depth. In the embodiment shown in FIG. 2B, a cumulative count of each type of alerts encountered so far within each configured frame of reference is calculated, to create a summary object 211 using an appropriate data structure, for example a JSON-like structure in this embodiment. Various time-based and depth proximity-based frames could be used, with some possible examples being alerts raised during the most recent 24 hours, 12 hours, 2 hours, or last hour. Similarly, the Summarizer may be configured to consider any alerts raised at measured bit depths within specific distances from the operation's current bit position, at any time in the operational history. Examples may include alerts raised within 100 m, 200 m, 500 m of the current position, and the extent of proximity-based frames of reference may optionally consider the direction of motion of the drill bit relative to the wellbore bottom in determining the particular boundary values defining the frame.

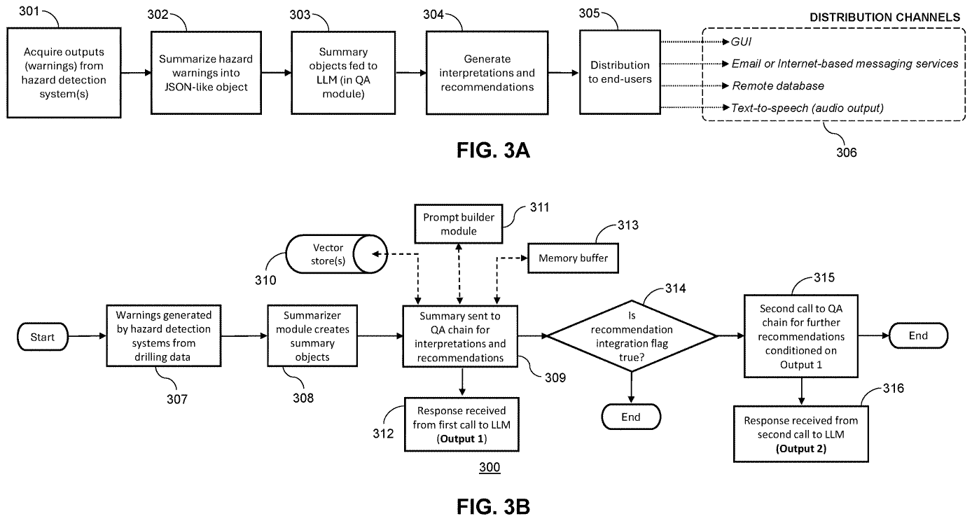

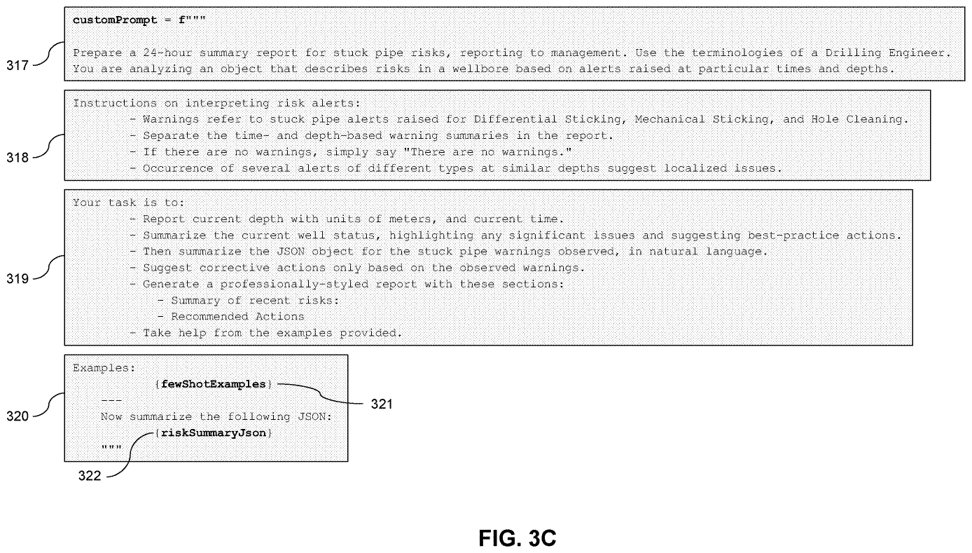

With reference to FIG. 3A, the process of obtaining summaries, interpretation and recommendations from a hazard detection system is implemented with scope of a module that is herein referred to as the “Querying Module”. A “query” or “querying” is defined in this context as a request for information or action, typically posed in natural language (text string) format, that seeks specific answers, data, or insights from a system, database, or model. Risk outputs from the linked hazard detection system 301 are processed by the Summarizer module 302, rendering a summary object (typically JSON-like), which are then structured into well-defined text queries and fed to the LLM 303 to elicit relevant responses 304 to trigger further analysis by humans monitoring for the hazard(s) of interest 305, or decision-making based on the provided input. The distribution channels 306 could be displaying on a GUI, notifications by email or internet-based messaging services, writing to remote databases, among others. In some embodiments, the system may be connected to multiple vector stores, where each vector store may contain a different set of information to support a particular set of users, where user sets might vary according to roles, geographic location, or any other characteristic distinguishing them from other users. When querying an LLM, the model is requested to use its knowledge in conjunction with its information retrieval and processing capabilities to interpret, summarize, or analyze data in a way that is relevant to the hazard or risk monitoring application, such as interpreting alerts, offering troubleshooting advice, or providing context for better-informed decision-making. This is achieved by combining a query with a prompt for an LLM. The objective is to construct an input prompt by embedding into it, information contained in the query, in such a way that provides the LLM with both the necessary context and a specific request, so it can generate an accurate, relevant response.

With reference to FIG. 3B, an example implementation of the process described in FIG. 3A is illustrated as a possible embodiment, where the linked operational hazard detection system is focused on risks of stuck pipe during subterranean well construction operations utilizing a rotary drilling rig. The linked stuck pipe detection system generates alerts 307 which in turn are processed by Summarizer module to create summary objects 308, which are received by the disclosed SIR system. These summary objects are then sent to QA chain 309, which utilizes (a) vector store(s) 310 for context retrieval in combination with a suitable prompt template provided by the prompt builder module 311 to generate interpretations and initial recommendations 312, denoted here as Output 1. Prompt templates provide structured formats with placeholders for dynamic inputs, which in this context includes information extracted from the hazard summary object or other user-provided text or questions. By allowing user queries to be integrated with automatically generated hazard scenario information and pre-defined instructions for the LLM, the custom-built prompts improve the efficiency and quality of generated responses across different contexts. Prompts serve as the guiding inputs for an LLM, influencing its contextual understanding and the tone or format of the generated responses. Empirically, it is observed that well-crafted prompts with minimized ambiguities improve the responses' accuracy and coherence, whether they are simple questions, structured commands, or detailed instructions with examples. A memory buffer 313 may be additionally used for storing past prompts and responses (conversation history), which may be utilized as further context in subsequent interactions. An additional Boolean variable is sent to the QA chain as part of the first query to the LLM, as a flag indicating whether a second query to LLM should be made as a follow-up or not. If this flag's value is True 314, a second call 315 is made to the LLM requesting recommended actions based on the received response from the first query (Output 1), which is utilized for context. The response generated from the second query 316 is here referred to as Output 2.

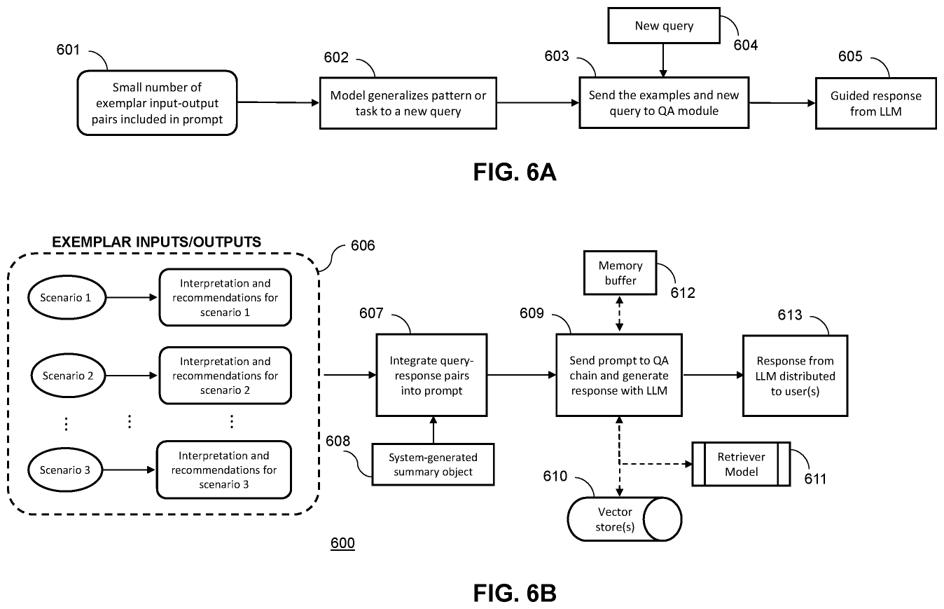

With reference to FIG. 3C, an example prompt template can be broken down into several components, in the form of text blocks. It will be apparent to a practitioner of ordinary skill in the art that various modifications to the prompt structure, format, and content could be implemented within the scope of this disclosure. In the simplified illustrative example provided in the Figure, the first component of the prompt is a preamble 317 section which introduces the task, use-case and some initial instructions for the LLM. This is followed by a section containing instructions on how to interpret the various alerts provided by the linked operational hazard detection system 318, in this case for a hazard detection system focused on stuck pipe risks in scope of subterranean well construction, and instructions on how to deal with cases where no relevant warnings were raised. The next component of the prompt outlines the specific task steps to be taken by the LLM 319, in the form of an itemized list. The final section is used for programmatically embedding dynamic input information into the prompt using placeholders and string-formatting 320. In this case, the embedded information includes some examples used for few-shot prompting 321 (discussed further in and FIGS. 6A and 6B), and the summarized risk information 322 as JSON-formatted text generated by the system's summarization step 210.

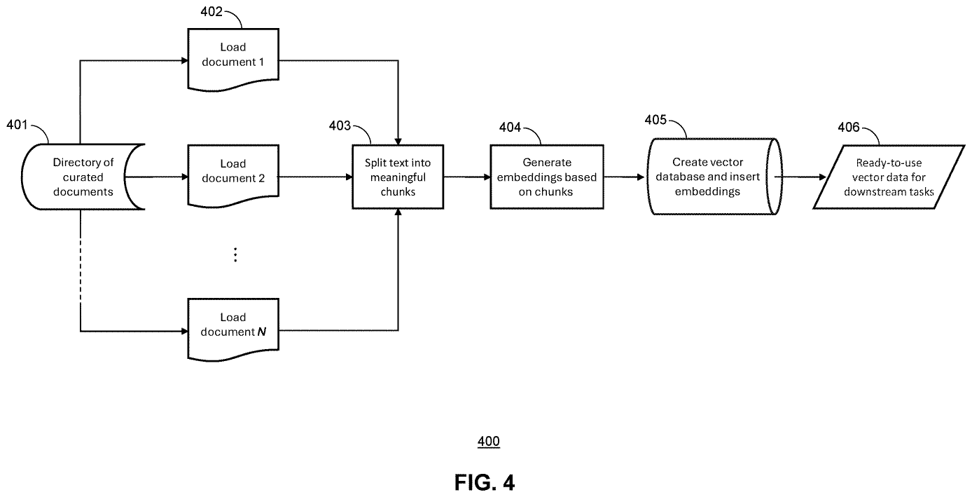

With reference to FIG. 4, an illustration of the process for setting up (a) vector store(s) utilized for RAG in conjunction with an LLM for improving response quality and mitigating LLM hallucinations is depicted. Embodiments of the SIR system may use one or more vector stores. A vector store, or vector database, efficiently manages vector embeddings, which are numerical representations of (usually unstructured) data types such as text and images; by mapping semantically similar items close together in a high-dimensional space. Typically, embeddings are generated using publicly available models such as BERT for text data, or CLIP for images. The process involves preprocessing data, converting it into embeddings, and storing them in commercially-available or open-sourced databases such as Pinecone, FAISS or Weaviate. Converting data into embeddings requires extracting semantic features and encoding them into high-dimensional vectors that capture relationships between words, phrases, or image features, enabling efficient similarity search and retrieval for AI applications. When queried as part of the RAG process, the system utilizes an appropriate tool to transform the input into an embedding, then performs a nearest neighbor search of embeddings stored in the vector database, and then retrieves the most relevant results using similarity metrics such as cosine similarity for use as context. The setup process for a database used for context retrieval in the SIR system starts with identifying or curating a set of documents 401 relevant to the hazard detection system, which are then used to populate the vector store; these documents might include, but are not limited to, Standard Operating Procedures, documents containing guidelines for interpreting the linked detection system's outputs, or technical articles and books relating to particular types of hazards. After loading the documents 402, the text is split to meaningful “chunks” 403; using these chunks, embeddings 404 are generated and then inserted into a created vector store 405, which is then used to augment the knowledge of the LLM using relevant context 406 retrieved from this vector store, rather than relying solely on static model knowledge derived from the LLM's original training process. “Text chunking” is the process of breaking large text data into smaller, manageable segments (chunks) for efficient processing, retrieval, and analysis in LLMs and vector stores. Text chunking involves pre-processing (cleaning text), segmentation (splitting based on length, semantics, or overlap), and embedding/storage (converting chunks into vectors for retrieval in LLM applications). The set of documents and created vector store may be customized to optimally support any particular embodiment or use-case.

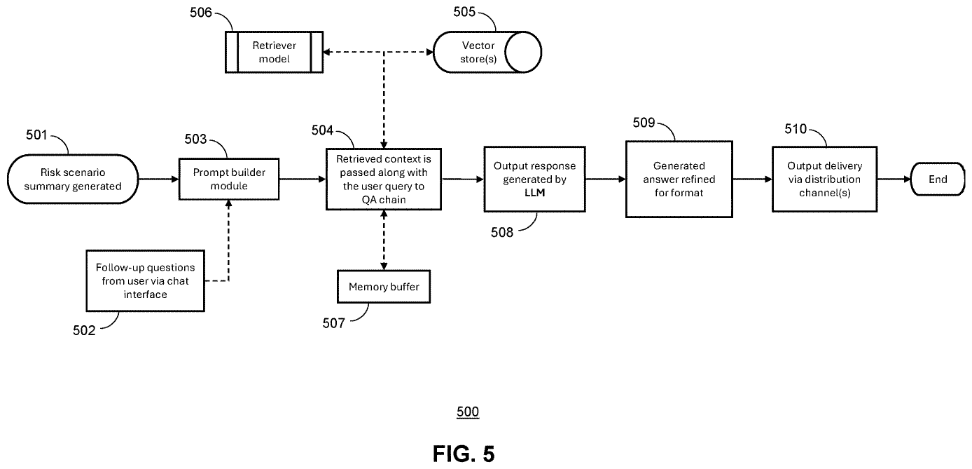

With reference to FIG. 5, in the usage of LLMs with RAG, a sequence of Question-Answer (QA) steps is often utilized to improve the relevance, accuracy and logical consistency of the generated text outputs; this concept is well-known to practitioners in the field. The QA chain module in the SIR system is designed to optimize the process of generating accurate interpretations and contextually-informed recommendations based on information received via the structured hazard summary objects 501 from the Summarizer module or an unstructured human query 502 sourced from a communication interface of a software application, such as a chat system. Advanced QA chains may integrate multiple steps like RAG or reasoning modules to improve accuracy. In this particular use case, more than one type of QA chain may be used depending on the requirements, but generically they will be referred to under the umbrella term “QA Chain”. The embodiments of a QA Chain described herein are exemplary and may vary depending on implementation choices, system configurations, and specific application requirements. Additionally, modifications, enhancements, or alternative approaches may be employed without departing from the scope of the invention as claimed. The first step in this sequence is acceptance of a system-generated query for a hazard summary object or a user-provided text query pertaining to the operational use case. The second step is processing of the input query, which may include steps such as embedding it into a prompt with instructions 503 using various prompt templates according to the type of query. The next step is context integration 504 using RAG. Context integration using RAG enhances a QA system by dynamically fetching relevant documents from one or more vector stores 505 using a suitable retriever mechanism 506 and injecting them into the prompt before generating a response. This approach ensures that the LLM has access to factual, up-to-date information, reducing hallucinations and improving answer accuracy. Relevant context can also be dynamically fetched from the memory buffer 507, which may include information on previous interactions with the QA chain module. Next, the LLM combines the user's query and the retrieved context (e.g., text, documents, or prior knowledge) to produce a contextually-informed response 508. The response from the LLM may be subjected to post-processing steps 509 such as structure modifications and/or formatting enhancements for display purposes. Structure optimization involves adjusting the presentation of the generated response for better readability and user engagement and subject to the distribution channel constraints. This could include converting long paragraphs into bullet points or numbered lists, making the content easier to digest, especially for step-by-step instructions or summarizations. The final step in this process is distributing responses through one or more channels 510 to the end-user(s).

With reference to FIG. 6A, an outline of a generic few-shot prompting technique is given, outlining its structure and application in guiding LLM responses. The core idea of few-shot prompting is to give the LLM a few relevant examples before asking a question. This helps the LLM to better understand the context and desired response type, leading to more accurate and meaningful answers aligned with the examples provided, without the need for retraining the model (tuning model parameters). The first step is the demonstration of a set of carefully chosen input-output pairs 601 used as exemplars, where the inputs are text queries relating to a particular hazard scenario, and the outputs are curated “best practice” interpretations and recommended actions for that particular hazard scenario. The next step is the LLM generalizing from these examples 602, where generalization in this context refers to the LLM generating relevant as well as coherent responses in cases where new (previously unseen) but “similar” inputs are received in the input query, and is underpinned by the LLM's capability to extracting underlying relationships and patterns from the few-shot examples. Once the exemplars are included in the prompt, the LLM 603 processes the user's question 604 by drawing context from the examples and generating a response 605 that aligns with the demonstrated patterns. The output generated by the LLM is influenced by the style, tone, and structure of the exemplars provided, helping the model match the desired response format.

With reference to FIG. 6B, an example implementation of the process described in FIG. 6A is illustrated as a possible embodiment in the context of a real-time hazard detection system focused on risks of stuck pipe during well construction operations utilizing a rotary drilling rig. The exemplar pairs 606 are chosen such that they cover a wide variety of hazard scenarios with plausible interpretations and good practice mitigating actions linked to each scenario to guide the LLM to utilize the exemplars' styles, tones and formats when generating responses. These exemplars may be sourced by various means, of which one possible option is creation by a subject matter expert, such as a drilling engineer, with a deep understanding of the operational context and use case. These exemplary query-response pairs are then integrated into the prompt 607 along with the system-generated hazard summary object 608 to create an input query. This augmented query is then sent to the QA chain module, and a response is generated 609 using RAG. In this process, a vector store 610 is used with a desired retriever model 611 and optionally a memory buffer 612 for providing context. Finally, the response from LLM is distributed 613 through one or more configured channels.

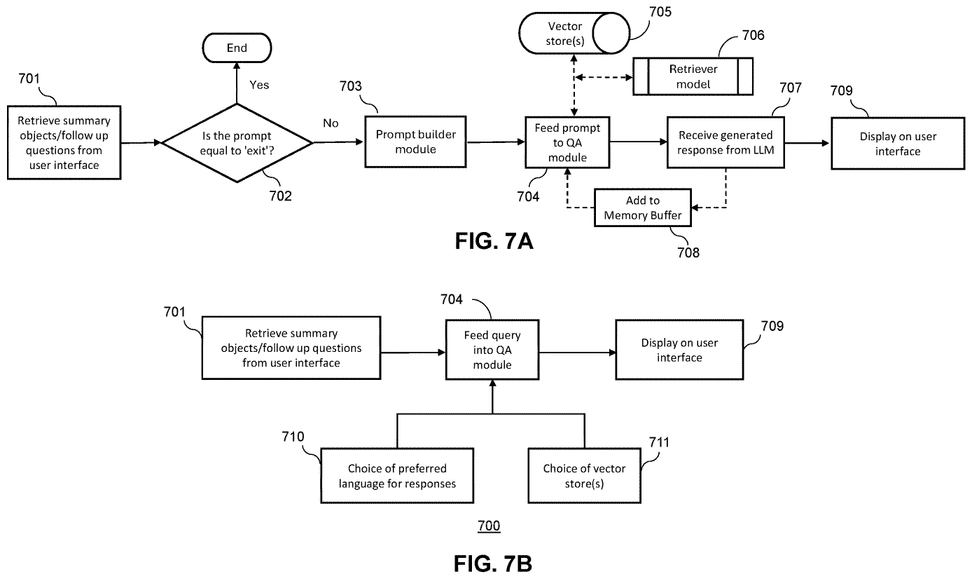

With reference to FIG. 7A, a possible embodiment that may include conversational agent functionality designed to generate interpretations and recommendations for summary objects and engage in natural language interactions with users, providing information, answering questions, and assisting with understanding the operational context is illustrated. A query 701 is initiated either after generating a hazard summary object or passing a text question from the user interface, which might be a follow-up question to a previous system-generated response containing interpretations and recommended actions for a particular risk scenario, or another general question. If the input is “exit” 702, the conversation agent should recognize it as a termination command and handle it appropriately. If the input is not “exit”, this input is pre-processed for the prompt builder module 703 that structures the prompt using a predefined template that provides guidance to the LLM according to the few-shot prompting technique. The prompt builder may structure queries differently according to the type of initial input, namely whether a system-generated hazard object is used as the information source, or a natural language text input from a human user. The pre-processed input is then sent to QA chain module 704 as described in FIG. 5A. The QA chain module processes the input and retrieves context from the vector store 705 using RAG with an appropriate retriever model 706 to generate a response 707. Few-shot prompting ensures responses follow a desired tone and format. To support multi-step conversations, the conversational agent functionality includes a memory buffer 708 for context handling, allowing incorporation of the conversation history into further interactions. The generated response is post-processed to refine the text according to desired display aesthetics. This response is then displayed on the user interface 709, and may optionally be distributed to users other than the one initiating the question via various channels.

With reference to FIG. 7B, an implementation of the user's selection of certain preferences is illustrated, which could include their preferred language for receiving text responses, or a choice relating to where they would like contextual information to be taken from, corresponding to a particular vector store in the backend systems. To enable users to receive responses in their preferred language, the system must support language selection, storage, and dynamic adaptation. Users can set their language via explicit selection 710, UI settings, or auto-detection, and this preference is then stored in session memory or a database for reference. Similarly, the user can select an information source 711 to draw context from, or this may be automatically set by the system based on information such as the geographic region of operations being monitored for hazards, device location or various other settings. Before sending a query to the LLM, the system retrieves the preferred language and structures the prompt accordingly to include this preference. Similarly, the system may utilize information source preferences in determining which vector store(s) to utilize for context retrieval. Users may also switch languages dynamically during interactions with a conversational agent, with the option to use fallback translation APIs being available if needed. Embodiments of the system typically should include functionality for handling edge cases such as unsupported languages and resetting or altering preferences. This approach supports personalized and multilingual experiences, improving the conversation agent's accessibility to users across different geographies with varying primary languages.

While the primary usage of the disclosed system concerns real-time provision of interpretations and recommendations in response to detected hazards on live operations, for various embodiments, it may be beneficial to utilize the SIR system on historical datasets in a “playback” mode for retrospective analysis. This serves to systematically generate sets of interpretations and recommendations, at various points during an operation, describing how that operation might have been improved at those points of reference, given the information that was available at that time. Following the retrospective analysis, any obtained learnings may also be fed back into the SIR system, through incorporating relevant examples into the few-shot prompting process used to guide the LLM, or adding any relevant documents to the vector store for use in the RAG pipeline. Embodiments utilizing the conversational agent functionalities may be particularly suited to retrospective analysis, due to their facilitation of follow-up questions by the user and incorporation of chat history, which may assist with improving understanding of historical scenarios of interest and extracting key learnings.

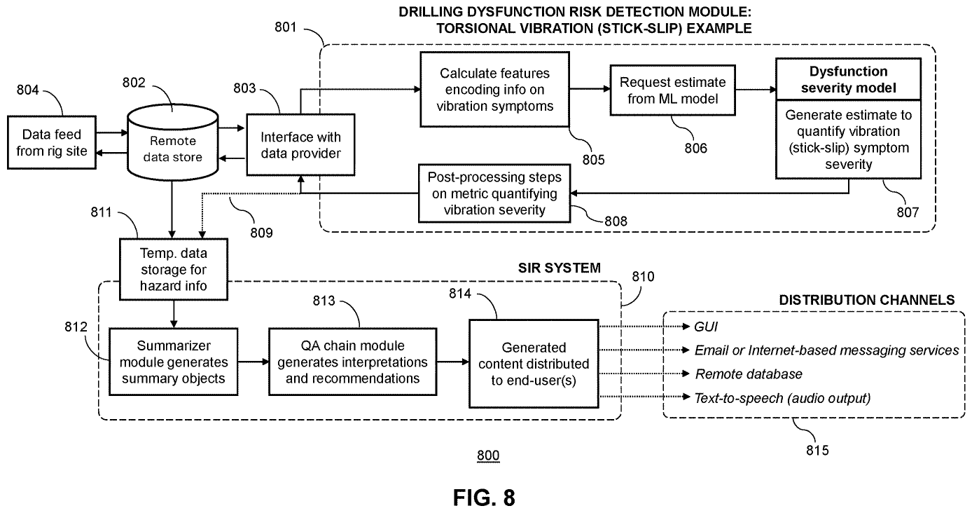

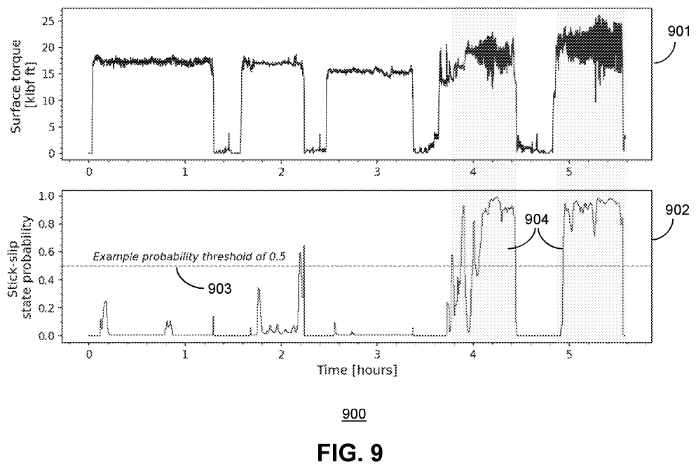

With reference to FIGS. 8 and 9, in an alternative embodiment, the linked hazard detection system may target risks and symptoms of drilling dysfunctions during subterranean well construction utilizing a rotary drilling rig. These dysfunctions that decrease drilling efficiency and pose increased risks of equipment damage may include various forms of vibration, such as torsional (stick-slip), lateral or axial vibrations affecting the tool string. An example embodiment of the SIR system integrates with a stick-slip risk detection system 801 that uses machine learning techniques to detect vibration symptoms and quantify their severity; this risk detector exchanges data with a remote data store 802 via interface logic 803, which in turn exchanges data with the rig site via a data feed 804 or other applicable data transfer protocol. An example of such a system is described in more detail in U.S. patent application Ser. No. 19/013,242 which is hereby incorporated by reference in its entirety. The detection system receives, and processes data measured from a plurality of rig-based sensors, for example rotary torque produced by a top-drive system and associated drill string rotary speeds, and calculates various numerical features encoding information about vibration symptoms affecting the drilling operations 805. These calculated features are used to transmit a request 806 to a machine learning model that generates an estimate of a metric that quantifies the stick-slip vibration severity 807 based on the input data. Example model-estimated metrics may include a probability that a stick-slip symptom is being observed, a categorical label indicating a severity level from a discrete set of severities, or a continuous variable representing a relevant stick-slip severity index. An illustration of a drilling dysfunction scenario using stick-slip probability as the metric of choice is shown in FIG. 9, which displays the variation of measured rotary torque 901 and stick-slip probability 902 over a 6-hour time interval. Probabilities may be monitored as a continuous variable acting as a diagnostic of vibration severity or may be converted into binary warnings by setting a threshold probability 903 above which a vibration warning is registered. The shaded intervals 904 indicate regions with severe torsional vibrations and high stick-slip probabilities estimated, corroborated by the highly erratic fluctuations in rotary torque during the same time range. Upon estimating a vibration severity metric, the detection system applies post-processing steps 808 for transmitting the drilling dysfunction risk outputs to consumers, which may be via a remote data store 802 or via a direct communication channel 809 to other software systems, for example the SIR system in this embodiment 810. Possible embodiments of the communication channel might utilize a message brokering system using a Publish-Subscribe paradigm, or connection via an Application Programming Interface (API). After receiving data from the data store 802 or directly from the hazard detection system 801, the SIR system 810 stores a history of detected hazard information in an appropriate data structure 811 to facilitate ready access by the Summarizer module 812 to the operational history while minimizing calls to external systems every time a summary is generated. Various methods or schemes may be used to summarize the risk information, including but not limited to time-variation in vibration severity, absolute values of vibration severity, or calculations of total time operational time where vibrations severities of certain magnitudes were recorded. Objects produced by the Summarizer module 812 are then sent to the QA chain module 813 responsible for building prompts for the LLM/RAG functionality and generating interpretations and recommendations relating to the current vibration risk scenario. This generated content is then made available to end users 814 via one or more possible distribution channels 815, which might include displaying in a GUI, email notifications or internet-based messaging services, writing to a remote database, or as audio output through use of a text-to-speech software tool. The document collection used to populate the vector store may include, but is not limited to, standard operating procedures for vibration mitigation, documentation relating to the drilling dysfunction risk detection system, and more general literature concerning vibrations encountered during drilling operations.

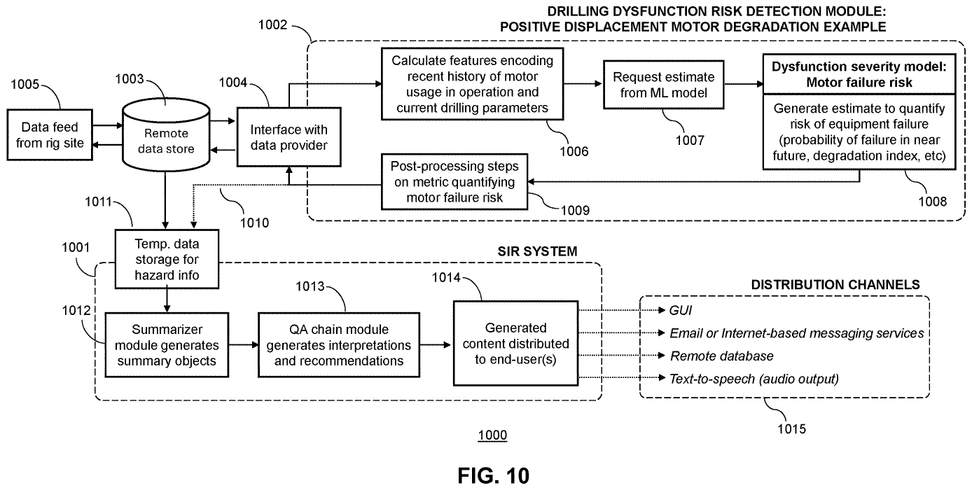

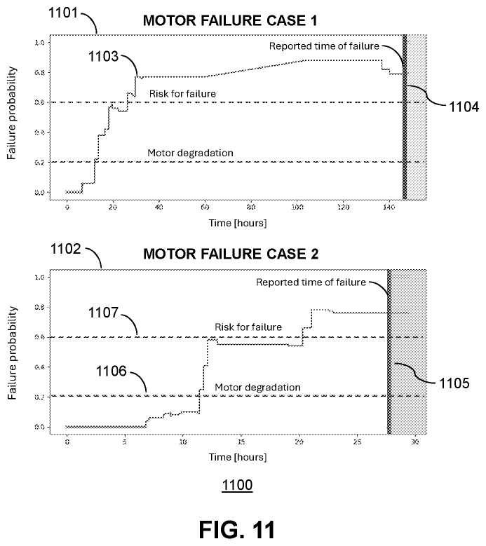

With reference to FIGS. 10 and 11, in an alternative embodiment, the SIR system 1001 may be linked to a real-time monitoring system targeting potential failure risks for downhole equipment 1002 used for well construction utilizing a rotary drilling rig, for example positive displacement motors, rotary steerable systems, measurement tools, stabilizers or drill bit components. An embodiment where the detected equipment failure hazard relates to positive displacement motor failures, and a machine learning model is used for risk identification, is illustrated in FIG. 10. The hazard detection system 1002 exchanges data with a remote data store 1003 via interface logic 1004, which in turn exchanges data with the rig site via a data feed 1005 or other applicable data transfer protocol. The detection system receives and processes data measured from a plurality of rig-based sensors, where this data might include values for hookload, bit and hole depths, weight-on-bit, standpipe pressure, rotary torque, rotary speed, flow rates and density readings for the mud pumped into the well, drilling rates of penetration, and optionally measurements from downhole sensors such as gamma ray readings, sonic compression or shear wave response logs, neutron porosity readings, among others. From this received data, a plurality of numerical features are computed which encode the recent history of motor usage in operations and current drilling parameters 1006. These features are sent in a request 1007 to a machine learning model that generates an estimate for a metric quantifying the risk of motor degradation or failure 1008. This risk metric may include one or more of a probability of failure in the near future or on various time horizons, a degradation or damage index, or a remaining useful lifetime estimate. Illustrative examples of how motor failure probability estimates generated by the machine learning model vary over an extended real-world drilling operation are provided in FIG. 11, where both Case 1 1101 and Case 2 1102 recorded increasing and high failure probabilities 1103 leading up to the actual motor failure events 1104, 1105. After applying post-processing steps 1009, the motor failure risk estimates may be sent back to the remote data store 1003 via the interface 1004 and/or directly transmitted 1010 to consumer software systems, such as the SIR system 1001 in this embodiment, and stored in a data structure recording detected hazard information 1011 over the operational history. As with the previous embodiment for vibration risk detection, in various implementations of this embodiment the communication channel might utilize a message brokering system using a Publish-Subscribe paradigm, or connection via an Application Programming Interface (API). When outputs from the SIR system 1001 are required, the Summarizer module 1012 focused on one or more risk indicators related to motor failures generates a summary object encoding detailed information on the current risk scenario. The summarized risk indicators may include time-evolution of metrics estimated by the embedded machine learning model 1008 such as failure risk probabilities, damage indices or remaining useful lifetime estimates, the reached level values of these metrics or one or more risk categories indicating a motor degradation regime 1106 or a failure risk regime 1107, or alternative information such as counts of alerts corresponding to risk-associated events identified by the hazard detector during the feature calculation process 1006, such as motor stalling. The produced summary object is then consumed by the prompt-builder and utilized by the QA chain module 1013 to generate a natural language risk summary and interpretations of the scenario, and recommendations for actions in accordance with best practices, using the LLM and RAG. The generated responses are then distributed 1014 to end-users through one or more channels 1015, which might include displaying in a GUI, email notifications or internet-based messaging services, writing to a remote database, or as audio output through use of a text-to-speech software tool. In this embodiment, example documents that are used to generate embeddings and populate the vector store used to provide additional context to the LLM via the RAG system may include, but are not limited to, manufacturers' documentation and operating guidelines, literature on predictive maintenance and the specific types of tools at risk of failure, technical or academic literature on the topic, or reports documenting usage of such tools in operations, see U.S. patent application Ser. No. 19/013,242 incorporated by reference above.

In various alternative embodiments, the automated hazard detection system may be replaced by a user interface of a software application facilitating user-provision of information about operational risks or hazard symptoms to the system, and optionally combined with conversational agent functionality. In each of these embodiments, the summarization module and prompt-builder functionality would be modified accordingly to process user-provided warnings, and possibly user-provided chat prompts to the conversational agent, as interface logic converting system-generated hazard information into a natural language form may not require the intermediate summarization step. In one possible variation to the embodiments utilizing a conversational agent for receiving inputs, speech-to-text (transcription) software tools may be used to transcribe spoken user input, replacing directly typed text input, before passing this to the conversational agent and prompt builder module. After building a prompt for the LLM based on user input and any available chat history, the techniques for which would be known by a practitioner in the art, interpretations relating to the input query and suggestions for mitigating actions may be generated using the process described in FIG. 7A.

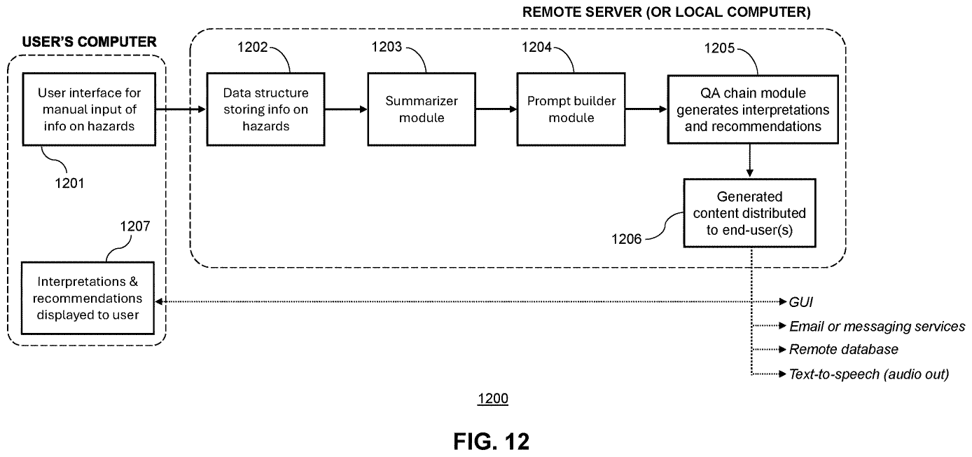

With reference to FIG. 12, an embodiment may be implemented that takes information on a particular set of one or more operational hazards directly from a first user, for example via a software user interface 1201 allowing this first to log one or more risks from a fixed selection of risk types. These risks are then added to an intermediate data structure 1202 to store a history of user-logged risks, which can then be accessed by the Summarizer module 1203 whenever summaries, interpretations and recommended actions are due to be generated. The points at which outputs are generated may vary across specific implementations, and could be immediate upon the first user logging a risk in the UI, or at regular intervals, or when requested by a second user who may be located remotely from the first user. When an output is due to be generated, the Prompt Builder module 1204 extracts information about a hazard scenario from the summary object provided by the Summarizer module 1203, and sends the custom-built prompt to the QA chain module 1205 that is responsible for querying the LLM and RAG system to generate interpretations for the risk scenario, and the recommended actions to take to mitigate any relevant risks. The generated content is then distributed to end-users 1206 via various possible channels, which might include a GUI monitored by the second user, email notifications, messages sent through internet-based messaging services, writing data to a remote database, audio outputs through an electronic speaker after applying text-to-speech software tools, or by displaying the outputs back in the GUI of the first user 1207 who logged the risks.

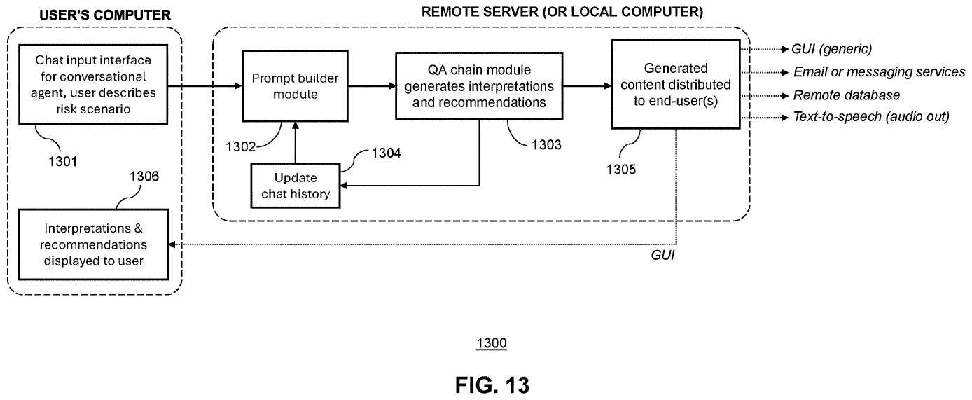

With reference to FIG. 13, an alternative embodiment where a first human user provides input information about hazards may utilize a conversational agent (“chat”) interface 1301 to receive information about risks faced by a set of operations, in a natural language format rather than a more fixed-structured input functionality as in the previous embodiment catering to a predefined set of risks. As inputs are in natural language form, an intermediate Summarizer module as an interface to a linked automated hazard detection system is not required in this specific embodiment, and the text inputs may be directly received by the prompt builder module 1302. This module constructs a custom prompt based on prior information about the type of hazard that is of interest (used in the few-shot prompting method), any other relevant initial guidance on prompt structure, in addition to any available chat history from past user interactions. Following this, the custom prompt is sent to the QA chain module 1303 responsible for generating interpretations and recommendations relevant to the user-provided hazard information, both current and historical. The input text and the LLM's response are then used to update the chat history 1304 ready for the next iteration, and the response content is distributed to the end-user(s) 1305 via one or more channels that might include a separate GUI from the conversational interface utilized by a second user, the user interface of the first user 1306, email notifications or internet-based messaging services, writing the data to a remote database, or audio outputs obtained through use of text-to-speech software tools and a playback device. In this embodiment, the vector store may contain embeddings for documents relating to the hazard of interest, standard operating procedures, contextual information on any non-standard elements of the monitored operations, best practices for mitigating hazards when identified, and any other technical literature relating the subject matter.

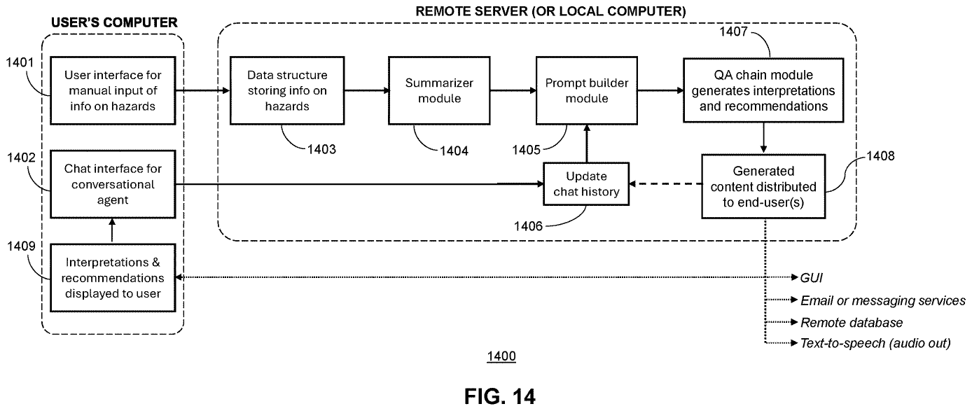

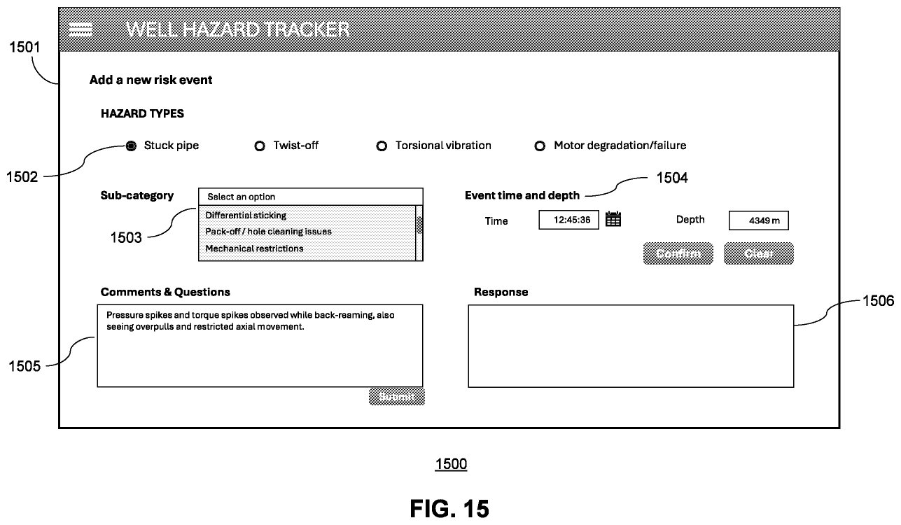

With reference to FIGS. 14 and 15, an alternative embodiment may combine elements from both of the previous two described embodiments. While various options are possible, one implementation may utilize both a user interface for manual input of information according to a predefined set of hazards 1401, and a conversational agent (“chat”) functionality 1402 facilitating follow up questions or provision of further information on the situation in a natural language format. Hazard information provided using the predefined inputs in the UI 1401 is sent to the SIR system and stored in a data structure 1403 that records the history of hazards reported during operations. The SIR system may be running on a remote server, or on the user's local computer depending on the specific setup. When a set of interpretations and recommendations relating to a summarized hazard are required to be generated, the Summarizer module 1404 queries data from the data structure recording hazard information, and creates a summary object that is in turn sent to the prompt builder module 1405 for creation of a custom prompt, which may also incorporate any available chat history 1406 obtained via the conversational interface 1402. The constructed prompt is then sent to the QA chain module 1407 that generates interpretations and recommendations based on the summarized hazard scenario and any user-provided natural language. The generated content is then distributed to end-users 1408 via one or more distribution channels, which may be the same set as in the previous two embodiments, or displayed back at the original user's computer through a dedicated GUI 1409 that also incorporates the conversational agent interface 1402. Various forms of user interface could be used in the scope of this embodiment; in FIG. 15, a mockup of one possible interface 1501 implementation is provided covering the key functionalities, which include: selection of a particular hazard type 1502 to report information on (in this example well various construction hazards may be selected via radio buttons); selection of a sub-category of issue relating to the chosen hazard type 1503 (via a dropdown menu in this example); specification of a time and depth for the reported risk event 1504; and finally a conversational agent interface where users may submit natural language queries 1505, and receive responses also in natural language form 1506.

Under the disclosed framework, all of or a subset of the aforementioned embodiments may also be readily combined into a single system, utilizing multiple linked hazard detection systems (which may include human-provided hazard inputs), an expanded summarization module, and document collections containing information relating to each linked hazard detection system. This provides a holistic view of possible operational hazards, interpretations into their underlying causes, and the methods which may be used to manage or mitigate those hazards and risks. Readers of ordinary skill in the art will recognize that various other hazard detection systems pertaining to well construction could be further incorporated into the disclosed framework to form an extended system for risk summarization, interpretation and recommendation generation.

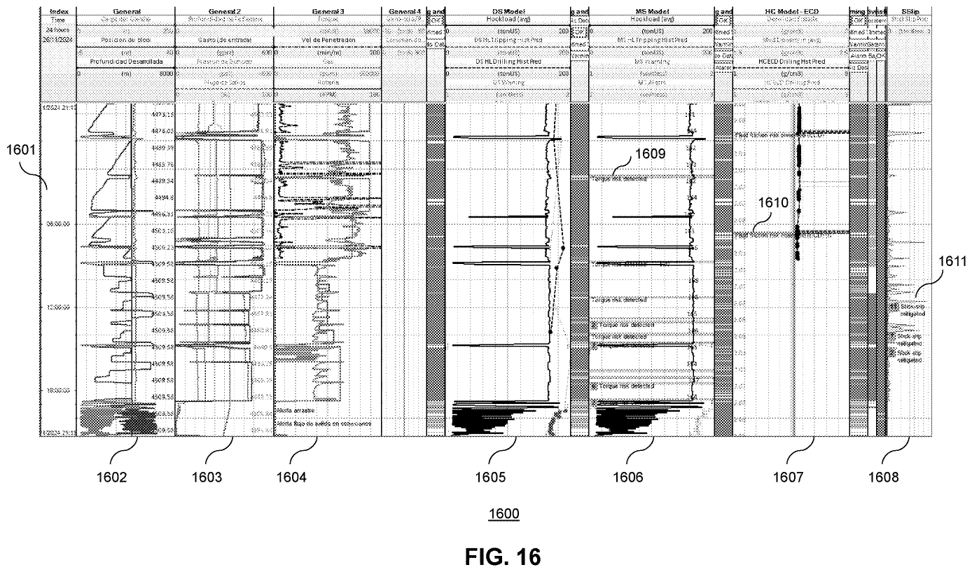

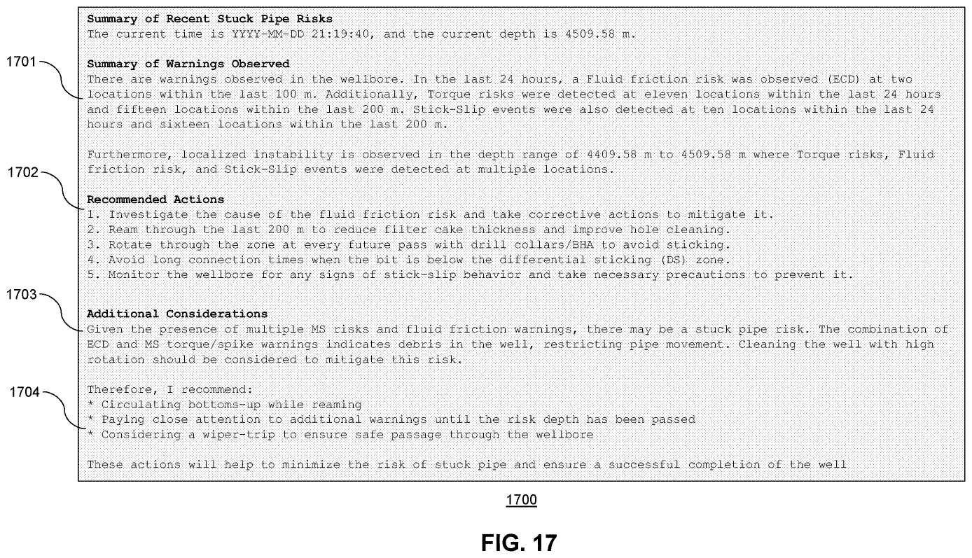

With reference to FIG. 16 and FIG. 17, sample results from a deployed hazard detection setup monitoring offshore drilling operations are illustrated in a screenshot from a commercial viewer software application (FIG. 16). Hazard detection systems targeting both stuck pipe risks and vibration risks were utilized in this case, and the warnings generated were (retrospectively) consumed by an implemented embodiment of the SIR system to generate an illustrative set of interpretations and recommendations for this specific scenario displayed in FIG. 16, which are presented in FIG. 17. The screenshot depicts a real-time monitoring display, with a time-index 1601, tracks for plotting time-based logs from the well construction operation such as depths, pressures, torques, rotary speeds and rates of penetration 1602, 1603, 1604, in addition to tracks depicting information on various types of operational risks, namely Differential Sticking (DS) 1605, Mechanical Sticking (MS) 1606, Hole Cleaning (HC) issues 1607, and torsional vibrations (stick-slip) 1608. In the displayed time interval, while pulling out of hole, multiple torque risk alerts 1609 were raised, in addition to alerts relating to poor hole cleaning 1610. Towards the later part of the interval, the frequency of torque risk alerts increased, indicating of increasing stuck pipe risk severity. Furthermore, symptoms of torsional vibrations were observed at various points and flagged by the detection system 1611, which in this off-bottom context is indicative of friction between the drill string and the wellbore (needed for the “sticking” component of stick-slip vibrations), and can be considered a secondary indicator of mechanical restriction, which may be due to geometry, obstructions, or most likely in this scenario cuttings accumulation due to poor hole cleaning, given the previously raised hole cleaning risk alerts 1610. In this case, the alerts were provided in real-time by monitoring engineers, who advised the rig to perform a wiper trip to clean the open-hole section of the wellbore, which helped to avert further issues and a stuck pipe incident. The alerts generated by the hazard detection systems and presented in FIG. 16 were used retrospectively as inputs to an implemented embodiment of SIR system, which was used to generate the text outputs shown in FIG. 17. The system-generated text matches the known contextual information about this risk scenario well, correctly highlighting hole cleaning risks in the headline summary 1701, in addition to mechanical sticking (torque spikes) and stick slip symptoms, for which various actions reflecting good practices for mitigating hole cleaning issues are recommended 1702. Note that the date of operations was removed for data anonymization purposes. The risk of poor hole cleaning issues is further emphasized in the “Additional Considerations” section 1703, which discusses the possibility of debris in the well evidenced by a combination of system-generated mechanical sticking and hole cleaning alerts, and suggests cleaning the well with high rotation for risk mitigation. The final part of the response text recommends circulation and a wiper trip 1704, which is the action that was actually taken by the team located at the well site that contributed to successfully avoiding a stuck pipe incident.

### Definitions

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention. Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure.

As noted herein, the disclosed embodiments have been presented for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, compositions, systems and apparatuses/devices that may further include any and all elements from any other disclosed methods, compositions, systems, and devices. In other words, elements from one or another disclosed embodiments may be interchangeable with elements from other disclosed embodiments. Moreover, some further embodiments may be realized by combining one and/or another feature disclosed herein with methods, compositions, systems and devices, and one or more features thereof, disclosed in materials incorporated by reference. In addition, one or more features/elements of disclosed embodiments may be removed and still result in patentable subject matter (and thus, resulting in yet more embodiments of the subject disclosure). Furthermore, some embodiments correspond to methods, compositions, systems, and devices which specifically lack one and/or another element, structure, and/or steps (as applicable), as compared to teachings of the prior art, and therefore represent patentable subject matter and are distinguishable therefrom (i.e. claims directed to such embodiments may contain negative limitations to note the lack of one or more features prior art teachings).

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

In addition, it should be understood that embodiments may include hardware, software, and electronic components or modules that, for purposes of discussion may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interface, and various connections (e.g., a system bus) connecting the components. In one embodiment, the software-based components can be containerized and deployed on Virtual Machines (Windows, Linux or similar) in a Data Center that are either cloud based (provided by Azure, AWS or similar) or by the user organization itself. In another embodiment, the software-based components can be deployed on a physical server.

Drilling parameters are defined as measured values of physical quantities relevant to the drilling operations, which include but are not limited to hookload, standpipe pressure, mud flow rates, mud densities (and other mud characteristics), rotary torque, rotary speed, block position, hole depth, bit depth, weight-on-bit (WOB), rate of penetration (ROP). These may be directly measured by sensors at the rig, or derived from one or more of the directly measured parameters, for example WOB is often calculated from the hookload. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### REFERENCES

The patents, patent applications, and other publications cited herein are incorporated by reference in their entirety as if each individual publication or patent application were specifically and individually set forth herein. In case of conflict between any incorporated reference and the present disclosure, the present disclosure controls.

### Patent References

| Publication Number | Publication Date | Title |
|---|---|---|
| US20210293130A1 | 2021 Sep. 23 | System and method to predict value and |
| | | timing of drilling operational parameters |
| WO2023067391A1 | 2023 Apr. 27 | System and method for predicting and |
| | | optimizing drilling parameters |
| WO 2024/057230 | 2024 Mar. 21 | Frequency based rig analysis |
| U.S. Pat. Ser. No. 19/013,242 | N/A | Systems and methods for optimizing rate of |
| | | penetration utilizing automated safeguards |
| | | against drilling dysfunctions and incidents |

### Non-Patent References

Robinson, T. S., Gomes, D., Meor Hashim, M. M. H. et al. 2022 (b). “Real-time Estimation Of Downhole Equivalent Circulating Density (ECD) Using Machine Learning And Applications”. Paper presented at SPE/IADC International Drilling Conference and Exhibition, March 2022, Galveston, TX, USA. SPE-208675-MS. DOI: https://doi.org/10.2118/208675-MS
Payrazyan, V. K., Robinson, T. S., 2023. “Leveraging Targeted Machine Learning for Early Warning and Prevention of Stuck Pipe, Tight Holes, Pack Offs, Hole Cleaning Issues and Other Potential Drilling Hazards”. Offshore Technology Conference, May 2023, Houston, Texas, USA. OTC-32169-MS. DOI: https://doi.org/10.4043/32169-MS
Gomes, D., Jaritz, T., Robinson, T. S. et al. 2024. “Enhancing Stuck Pipe Risk Detection in Exploration Wells Using Machine Learning Based Tools: A Gulf of Mexico Case Study”, IADC/SPE International Drilling Conference and Exhibition, Galveston, Texas, USA, March 2024. SPE-217963-MS. DOI: https://doi.org/10.2118/217963-MS
Robinson, T. S., Mohammed Arshad, P., Revheim, O. E., Regan, M., Bekkeheien, P. 2025. “System for Real-Time Rate of Penetration Optimization Using Machine Learning with Integrated Preventive Safeguards Against Hole Cleaning Issues and Stick-Slip”. SPE/IADC Drilling Conference and Exhibition, March 2025, Stavanger, Norway. SPE-223713-MS. DOI: https://doi.org/10.2118/223713-MS

What is claimed is:

1. A method for integrating one or more real-time operational hazard detection systems with other systems responsible for utilizing information pertaining to detected hazards and generating interpretations and recommendations for mitigating actions, comprising:
receiving data from one or more hazard detection systems and inserting these risk outputs into a data structure for storage;
summarizing a set of risk output data into a data structure aggregating these risk outputs over various frames of reference based on time, depth, displacement or other metrics, wherein the risk output data comprises warnings, alarms, or changes in numerical metrics including at least one of failure risk probabilities, damage indices, remaining useful lifetimes, or other operation-specific metrics;
building a custom natural language prompt that embeds the summarized hazard scenario information into a template containing pre-defined instructions pertaining to the relevant hazards;
generating, through sending the constructed prompt to a Question-Answer (QA) chain system utilizing a Large Language Model (LLM), one or more connected knowledge bases or external databases from which to draw context, and the technique of Retrieval Augmented Generation (RAG), a first natural language response consisting of interpretations for the hazard scenario relating to the underlying mechanisms driving risks and a set of initial recommendations for actions to mitigate the risks in accordance to the specific operational context and any associated best-practices;
post-processing the first received response to suit a specified format, structure or style;
sending a second prompt to the QA chain and LLM to generate a follow-up set of more detailed recommended actions for risk mitigation using the first generated response as context in the prompt;
post-processing the second received response to suit a specified format, structure or style;
combining the first and second responses into a final, more detailed, response; and
distributing the final response via one or more channels to end-users for consumption of the generated insights.

2. The method of claim 1, where the hazard detection system utilizes machine learning techniques within the risk detection methodology.

3. The method of claim 1, where human users provide hazard information through at least one of: (i) a pre-defined structure through a user interface, or (ii) natural language format through a conversational agent interface, wherein the human-provided hazard information is utilized as the hazard detection system.

4. The method of claim 1, further comprising performing retrospective analysis on historical datasets in a playback mode to systematically generate sets of interpretations and recommendations at various points during a past operation.

5. The method of claim 1, where a physics-based algorithm is utilized for the hazard detection system.

6. The method of claim 1, where the linked hazard detection system identifies one or more risk indicators for stuck pipe incidents that may occur during well construction using a rotary drilling rig, and wherein interpretations and recommendations for mitigating actions are generated for the detected stuck pipe risks.

7. The method of claim 1, where the linked hazard detection system identifies one or more risk indicators for drilling dysfunctions that may occur during well construction using a rotary drilling rig, and wherein interpretations and recommendations for mitigating actions are generated for the detected drilling dysfunction risks.

8. The method of claim 1, where the linked hazard detection system identifies one or more risk indicators for equipment failures that may occur during well construction using a rotary drilling rig, and wherein interpretations and recommendations for mitigating actions are generated for the detected equipment failure risks.

9. The method of claim 8, wherein the equipment failure risks specifically relate to positive displacement motor degradation or failure during drilling operations.

10. The method of claim 1, where a combination of two or more hazard detection systems are used in conjunction with each other.

11. The method of claim 1, where one or more vector databases are used for storing embeddings representing a set of documents relating to the operational hazards of interest, which are retrieved as context during the RAG process.

12. The method of claim 1, where the hazard detection systems consume both time-series data and depth-indexed data.

13. The method of claim 1, where one of the output distribution channels is a targeted communication message to one or more individuals or groups via email or other internet-based messaging services.

14. The method of claim 1, where one of the output distribution channels is a Graphical User Interface on a personal computer, laptop, mobile device or shared screen.

15. The method of claim 1, where one of the output distribution channels is an electronic speaker outputting audio corresponding to the text responses, following application of a text-to-speech conversion software tool.

16. The method of claim 11, where two or more tailored vector databases are used to provide specific context for different types of end users, which may vary by: geographic location; types of operations in which they are involved; or types of hazards they are focused on.

17. A system for integrating one or more operational hazard detection systems with other systems responsible for receiving and summarizing information pertaining to detected hazards, and generating interpretations and recommendations for mitigating actions, comprising:
at least one processor;
a memory storing computer-readable instructions that, when executed by the at least one processor, cause the system to:
receive data from one or more hazard detection systems relating to an operation carrying some risks which are to be avoided;
preprocess the received data;
insert the preprocessed data into a data store to be queried during the operations;
execute a summarization module that processes the risk output data that involves at least one of the following information types including warnings, alarms, or changes in numerical metrics such as failure risks probabilities, damage indices, remaining useful lifetimes, or other operation-specific metrics, into a data structure aggregating these risk outputs over various frames of reference based on time, depth, displacement or other metrics;
execute a prompt-builder module that builds a custom natural language prompt which embeds the summarized hazard scenario information into a template containing pre-defined instructions pertaining to the relevant hazards;
execute a QA chain module that receives the custom constructed prompt and generates through use of an LLM, one or more connected knowledge bases or external databases from which to draw context, and the technique of RAG, a first natural language response consisting of interpretations for the hazard scenario relating to the underlying mechanisms driving risks and a set of initial recommendations for actions to mitigate the risks in accordance to the specific operational context and any associated best-practices;
post-process the first received response to suit a specified format, structure or style;
send a second prompt to the QA chain and LLM to generate a follow-up set of more detailed recommended actions for risk mitigation using the first generated response as context in the prompt;
post-process the second received response to suit a specified format, structure or style;
combine the first and second responses into a final, more detailed, response; and
distribute the final response via one or more channels to end-users for consumption of the generated insights.

18. The system of claim 17, wherein the system is configured to detect and mitigate risks related to at least one of: stuck pipe risks during well construction operations utilizing a rotary drilling rig; vibration risks during drilling operations; and positive displacement motor degradation or failure risks during drilling operations.

19. The system of claim 17, wherein the system is configured to receive hazard information from human users through a user interface or conversational agent interface, and wherein the system comprises a memory buffer for storing conversation history for use as context in subsequent interactions.

20. The system of claim 17, wherein the system is configured to support user preferences for receiving responses in different languages and for selecting specific information sources from which to retrieve contextual information.
